(19) United States
(12) Patent Application Publication
(10) Pub. No.: US 2023/0039890 A1
(43) Pub. Date: Feb. 9, 2023

(54) SYSTEM AND METHOD FOR ENABLING A CUSTOMER SUPPORT INTERACTION IN MULTIPLE CHANNELS IN PARALLEL

(71) Applicant: OC SUB II, INC., San Ramon, CA (US)

(72) Inventors: Venkatesh Krishnaswamy, San Ramon, CA (US); David Skiba, Golden, CO (US); Shalini Yajnik, Berkeley Heights, NJ (US); Ajita John, Holmdel, NJ (US)

(21) Appl. No.: 17/397,742

(22) Filed: Aug. 9, 2021

(51) Int. Cl. H04M 3/523; H04M 7/00

(52) U.S. Cl. CPC H04M 3/5238; H04M 7/0042; H04M 7/0057

(57) ABSTRACT

A processor-implemented method of enabling a customer support interaction in multiple channels in parallel is provided. The processor-implemented includes (i) receiving a call at a contact center from a customer, (ii) providing a notification to the customer with reference to a hold time to reach a live human agent at a first live channel, (iii) selecting at least one automation task to be performed for a customer's requirement by a virtual agent at a second non-live channel, and (iv) enabling transfer of the customer from the first live channel to the second non-live channel with the virtual agent and communicating the at least one automation task to be performed for the customer's requirement to the virtual agent at the second non-live channel. The at least one automation task is a series of steps performed by the virtual agent to complete an objective.

### BACKGROUND

### Technical Field

Embodiments of this disclosure generally relate to multi-channel customer management, more particularly, to a system and method for enabling a customer support interaction in multiple channels in parallel.

### Description of the Related Art

When customers reach a contact center today, they may end up with long hold times to reach a person. The customer chooses the channel to contact the business (voice, chat, email, SMS, social) based on their convenience and the channels exposed by the business. It may be possible that the customer can get faster service through another channel offered by the business. It is common for a business to offer up chat when voice hold times are long. Existing approaches involve offering callbacks or scheduled support times to reduce a current spike in customer demand.

While this offer may help the business remove the customer from the current situation, it can be problematic for customers requiring a solution now or customers who are not confident their request may be handled with the high priority waiting on the phone indicates.

Accordingly, there remains a need for a more efficient method for mitigating and/or overcoming drawbacks associated with current methods.

### SUMMARY

In view of the foregoing, an embodiment herein provides a processor-implemented method of enabling a customer support interaction in multiple channels in parallel. The processor-implemented includes (i) receiving a call at a contact center from a customer, (ii) providing a notification to the customer with reference to a hold time to reach a live human agent at a first live channel, (iii) selecting at least one automation task to be performed for a customer's requirement by a virtual agent at a second non-live channel, and (iv) enabling transfer of the customer from the first live channel to the second non-live channel with the virtual agent and communicating the at least one automation task to be performed for the customer's requirement to the virtual agent at the second non-live channel. The at least one automation task is a series of steps performed by the virtual agent to complete an objective.

In some embodiments, the method includes (i) determining that the live human agent is available in the first live channel and (ii) enabling the transfer of the customer from the second non-live channel to the first live channel if the live human agent becomes available in the first live channel.

In some embodiments, the multiple channels include real-time channels and non-real time channels. In some embodiments, the real-time channels are at least one of a voice channel or a video channel. In some embodiments, the non-real time channels are chat, messaging, social, or SMS.

In some embodiments, communicating the at least one automation task to be performed for the customer's requirement includes communicating steps that are completed by the virtual agent at the second non-channel, to the live human agent at the first live channel. In some embodiments, the at least one automation task includes a start point, intermediate steps, and multiple completion paths.

In some embodiments, the steps are determined by at least one of (i) static definition, (ii) dynamic data based on a question and an answer with the customer, or (iii) Artificial intelligence (AI) driven prediction or recommendation based on customer input, dynamic data based on customer profile and transaction history, and other external indicators.

In some embodiments, enabling the transfer of the customer from the second non-live channel to the first live channel by determining that the at least one automation task to be performed for the customer's requirement is completed by the virtual agent at the second non-live channel.

In some embodiments, the method includes enabling the customer to select the at least one automation task to be performed by the virtual agent at the second non-live channel.

In some embodiments, the method includes when the live human agent is available at the first live channel, checking, by the virtual agent, whether the customer wants to continue to in the second non-live channel to complete the at least one automation task, or transfer to the first live channel to complete the at least one automation task.

In some embodiments, the method includes if the at least one automation task is completed at the second non-live channel, moving the customer from the second non-live channel to the first live channel with a priority queue that is different than an original queued priority in the first live channel.

In some embodiments, the method includes if the at least one automation task is completed at the second non-live channel, moving the customer from the second non-live channel to the first live channel in a same queue position as when the customer left the first live channel.

In some embodiments, the method includes providing a notification to switch the customer from the second non-live channel with the virtual agent to the first live channel with the live human agent if the live human agent is available in the first live channel at the contact center.

In some embodiments, communicating a state and context that correspond to an interaction between the customer and the virtual agent in the second non-live channel, to the live human agent in the first live channel.

In some embodiments, the context includes (i) information that corresponds to a name, an account number, a reason for contact, product information, problem description, photos, videos that are gathered by the virtual agent from the customer, (ii) pre-launch information that includes browser history, a location, an identity, information of the customer device associated with the customer.

In some embodiments, the state is at least one of a current business situation that includes information related to a business busy level, hours of operation, current level achieved on a promotion or sales target, or other current metrics related to business capacity or goals.

In some embodiments, the method includes determining, by the virtual agent in the second non-live channel, that a specific task needs to be performed by the live human agent at the first live channel for the customer's requirement.

In one aspect, a system for enabling a customer support interaction in multiple channels in parallel is provided. The system includes a memory that stores a set of instructions and a processor that executes the set of instructions. The processor is configured to (i) receive a call at a contact center from a customer, (ii) provide a notification to the customer with reference to a hold time to reach a live human agent at a first live channel, (iii) select at least one automation task to be performed for a customer's requirement by a virtual agent at a second non-live channel, and (iv) enable transfer of the customer from the first live channel to the second non-live channel with the virtual agent and communicating the at least one automation task to be performed for the customer's requirement to the virtual agent at the second non-live channel. The at least one automation task is a series of steps performed by the virtual agent to complete an objective.

In some embodiments, the processor is further configured to determine that the live human agent is available in the first live channel and enable the transfer of the customer from the second non-live channel to the first live channel if the live human agent becomes available in the first live channel.

In some embodiments, the processor communicates the at least one automation task to be performed for the customer's requirement includes communicates steps that are completed by the virtual agent at the second non-live channel, to the live human agent at the first live channel. In some embodiments, the at least one task includes a start point, intermediate steps, and multiple completion paths.

In some embodiments, the processor enables the transfer of the customer from the second non-live channel to the first live channel by determining that the at least one automation task to be performed for the customer's requirement is completed by the virtual agent at the second non-live channel.

In some embodiments, the processor is further configured to move the customer from the second non-live channel to the first live channel with a priority queue that is different than an original queued priority in the first live channel if the at least one automation task is completed at the second non-live channel.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 is a block diagram of a system that enables a customer support interaction in multiple channels in parallel according to some embodiments herein;

FIG. 2 illustrates an exploded view of a server of FIG. 1 according to an embodiment herein;

FIGS. 3A-3B illustrate user interface views of a customer device of FIG. 1 that depicts providing a notification to the customer with reference to a hold time to reach a live human agent at a first live channel according to some embodiments herein;

FIGS. 4A-4B illustrate user interface views of the customer device of FIG. 1 that depicts checking, by a virtual agent, whether the customer wants to continue to in a second non-live channel to complete an automation task according to some embodiments herein;

FIGS. 5A-5C illustrate user interface views of the customer device of FIG. 1 that depicts transferring the customer to a priority queue that is different than an original queued priority in the first live channel according to some embodiments herein;

FIG. 6 is a user interface view that depicts communicating a context that corresponds to an interaction between the customer and the virtual agent in the second non-live channel, to the live human agent in the first live channel according to some embodiments herein;

FIG. 7 is a flow diagram that illustrates a method of enabling a customer to call a priority queue in a first live channel according to some embodiments herein;

FIG. 8 is a flow diagram that illustrates a processor-implemented method for enabling a customer support interaction in multiple channels in parallel according to some embodiments herein; and

FIG. 9 is a block diagram of a schematic diagram of a device used in accordance with embodiments herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

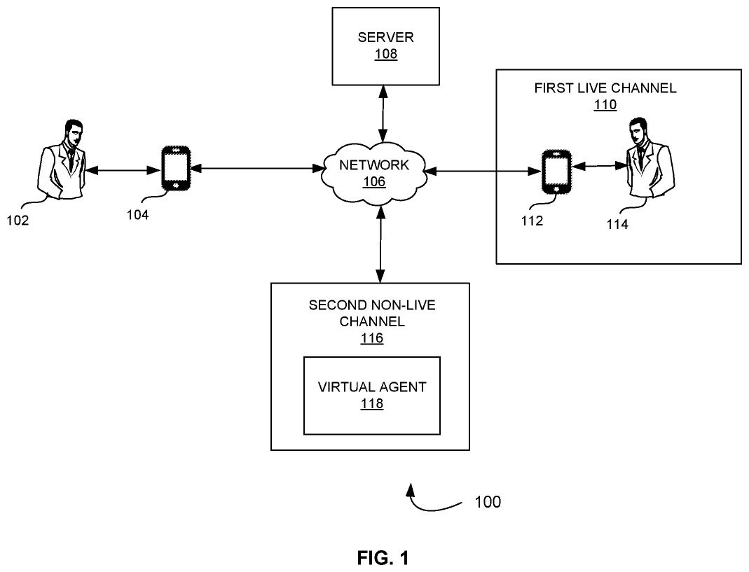

As mentioned, there remains a need for a system and method for enabling a customer support interaction in multiple channels in parallel. Referring now to the drawings, and more particularly to FIGS. 1 through 9, where similar reference characters denote corresponding features consistently throughout the figures, there are shown preferred embodiments.

FIG. 1 is a block diagram 100 of a system that enables a customer support interaction in multiple channels in parallel according to some embodiments herein. The block diagram 100 includes a customer 102, a customer device 104, a network 106, a server 108, a first live channel 110 that includes a live human agent device 112 and a live human agent 114, and a second non-live channel 116 that includes a virtual agent 118. The customer 102 may call a contact center using the customer device 104 associated with the customer 102. The server 108 receives the call at the contact center from the customer 102. The server 108 provides a notification to the customer 102 with reference to a hold time to reach the live human agent 114 at the first live channel 110.

The server 108 provides the notification to the customer device 104 of the customer 102 through the network 106. In some embodiments, the network 106 is a wired network. In some embodiments, the network 106 is a wireless network. In some embodiments, the network 106 is a combination of a wired network and a wireless network.

In some embodiments, the network 106 is the Internet.

In some embodiments, the customer device 104, without limitation, may be selected from a mobile phone, a Personal Digital Assistant (PDA), a tablet, a desktop computer, or a laptop. A list of devices that are capable of functioning as the server 108, without limitation, may include a mobile phone, a Personal Digital Assistant (PDA), a tablet, a desktop computer, or a laptop.

The server 108 selects one or more automation tasks to be performed for a customer's requirement by the virtual agent 118 at the second non-live channel 116. The one or more automation tasks are a series of steps performed by the virtual agent 118 to complete an objective.

The server 108 enables transfer of the customer 102 from the first live channel 110 to the second non-live channel 116 with the virtual agent 118 and communicates the one or more automation tasks to be performed for the customer's requirement to the virtual agent 118 at the second non-live channel 116. In some embodiments, the multiple channels include real-time channels and non-real time channels. In some embodiments, the real-time channels are at least one of a voice channel or a video channel. In some embodiments, the non-real time channels are chat, messaging, social, or SMS.

In some embodiments, the server 108 communicates the one or more automation tasks to be performed for the customer's requirement includes communicating steps that are completed by the virtual agent 118 at the second non-live channel 116 to the live human agent 114 at the first live channel 110. The one or more automation tasks may include a start point, intermediate steps, and multiple completion paths. The steps may be determined by at least one of (i) static definition, (ii) dynamic data based on a question and an answer with the customer 102, or (iii) Artificial intelligence (AI) driven prediction or recommendation based on customer input, dynamic data based on customer profile and transaction history, and other external indicators such as historical contact center volume trends, known similar issues with a product shipped, outages by other businesses (air, bus, power, network).

In some embodiments, the server 108 enables the transfer of the customer 102 from the second non-live channel 116 to the first live channel 110 by determining that the one or more automation tasks to be performed for the customer's requirement is completed by the virtual agent 118 at the second non-live channel 116.

In some embodiments, the server 108 determines that the live human agent 114 is available in the first live channel 110. In some embodiments, the server 108 enables the transfer of the customer 102 from the second non-live channel 116 to the first live channel 110 if the live human agent 114 is available in the first live channel 110.

The server 108 may enable the customer 102 to select the one or more automation tasks to be performed by the virtual agent 118 at the second non-live channel 116. In some embodiments, when the live human agent 114 is available at the first live channel 110, the virtual agent 118 checks whether the customer 102 wants to (i) continue in the second non-live channel 116 to complete the one or more automation tasks, or (ii) transfer to the first live channel 110 to complete the one or more automation tasks.

In some embodiments, the server 108 moves the customer 102 from the second non-live channel 116 to the first live channel 110 with a priority queue that is different than an original queued priority in the first live channel 110 if the one or more automation tasks are completed at the second non-live channel 116.

In some embodiments, the server 108 moves the customer 102 from the second non-live channel 116 to the first live channel 110 in a same queue position as when the customer 102 left the first live channel 110 if the one or more automation tasks are completed at the second non-live channel 116.

In some embodiments, the server 108 provides the notification to switch the customer 102 from the second non-live channel 116 with the virtual agent 118 to the first live channel 110 with the live human agent 114 if the live human agent 114 becomes available in the first live channel 110 at the contact center.

In some embodiments, the server 108 communicates a state and context that correspond to an interaction between the customer 102 and the virtual agent 118 in the second non-live channel 116, to the live human agent 114 in the first live channel 110. The context may include (i) information that corresponds to a name, an account number, a reason for contact, product information, problem description, photos, videos that are gathered by the virtual agent 118 from the customer 102, (ii) pre-launch information that includes browser history, a location, an identity, information of the customer device 104 associated with customer 102.

The state may be at least one of a current business situation that includes information related to a business busy level, hours of operation, current level achieved on a promotion or sales target, or other current metrics related to business capacity or goals.

In some embodiments, the virtual agent 118 in the second non-live channel 116 determines that a specific task needs to be performed by the live human agent 114 at the first live channel 110 for the customer's requirement.

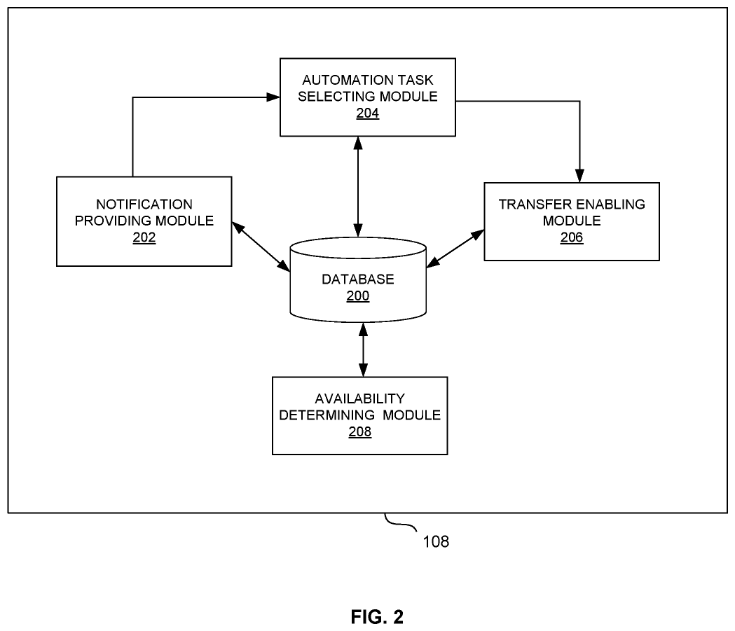

FIG. 2 is a block diagram of the server 108 of FIG. 1 according to some embodiments herein. The server 108 includes a database 200, a notification providing module 202, an automation task selecting module 204, a transfer enabling module 206, and an availability determining module 208. The notification providing module 202 receives a call at a contact center from the customer 102. The notification providing module 202 provides a notification to the customer 102 with reference to a hold time to reach the live human agent 114 at the first live channel 110. The automation task selecting module 204 selects an automation task to be performed for a customer's requirement by the virtual agent 118 at the second non-live channel 116. The transfer enabling module 206 enables transfer of the customer 102 from the first live channel 110 to the second non-live channel 116 with the virtual agent 118. The transfer enabling module 206 communicates the automation task to be performed for the customer's requirement to the virtual agent 118 at the second non-live channel 116.

In some embodiments, the transfer enabling module 206 communicates the automation task to be performed for the customer's requirement by communicating steps that are completed by the virtual agent 118 at the second non-live channel 116 to the live human agent 114 at the first live channel 110. In some embodiments, the automation task includes a start point, intermediate steps, and multiple completion paths.

In some embodiments, the steps are determined by at least one of (i) static definition, (ii) dynamic data based on a question and an answer with the customer 102, or (iii) Artificial intelligence (AI) driven prediction or recommendation based on customer input, dynamic data based on customer profile and transaction history, and other external indicators.

In some embodiments, the transfer enabling module 206 enables the transfer of the customer 102 from the second non-live channel 116 to the first live channel 110 by determining that the automation task to be performed for the customer's requirement is completed by the virtual agent 118 at the second non-live channel 116.

The availability determining module 208 determines that the live human 114 agent is available in the first live channel 110. The transfer enabling module 206 enables the transfer of the customer 102 from the second non-live channel 116 to the first live channel 110 if the live human agent 114 is available in the first live channel 110.

In some embodiments, the transfer enabling module 206 moves the customer 102 from the second non-live channel 116 to the first live channel 110 with a priority queue that is different than an original queued priority in the first live channel 110 if the automation task is completed at the second non-live channel 116.

In some embodiments, the transfer enabling module 206 moves the customer 102 from the second non-live channel 116 to the first live channel 110 in a same queue position that is the same as the queue position of the customer 102 previously interacted at the first live channel 110, if the automation task is completed at the second non-live channel 116.

In some embodiments, the notification providing module 202 provides the notification to switch the customer 102 from the second non-live channel 116 with the virtual agent 118 to the first live channel 110 with the live human agent 114 if the live human agent 114 is available in the first live channel 110 at the contact center.

In some embodiments, the transfer enabling module 206 communicates a state and context that correspond to an interaction between the customer 102 and the virtual agent 118 in the second non-live channel 116, to the live human agent 114 in the first live channel 110. The context may include (i) information that corresponds to a name, an account number, a reason for contact, product information, problem description, photos, videos that are gathered by the virtual agent 118 from the customer 102, (ii) pre-launch information that includes browser history, a location, an identity, information of the customer device 104 associated with customer 102. In some embodiments, the state is at least one of a current business situation that includes information related to a business busy level, hours of operation, current level achieved on a promotion or sales target, or other current metrics related to business capacity or goals.

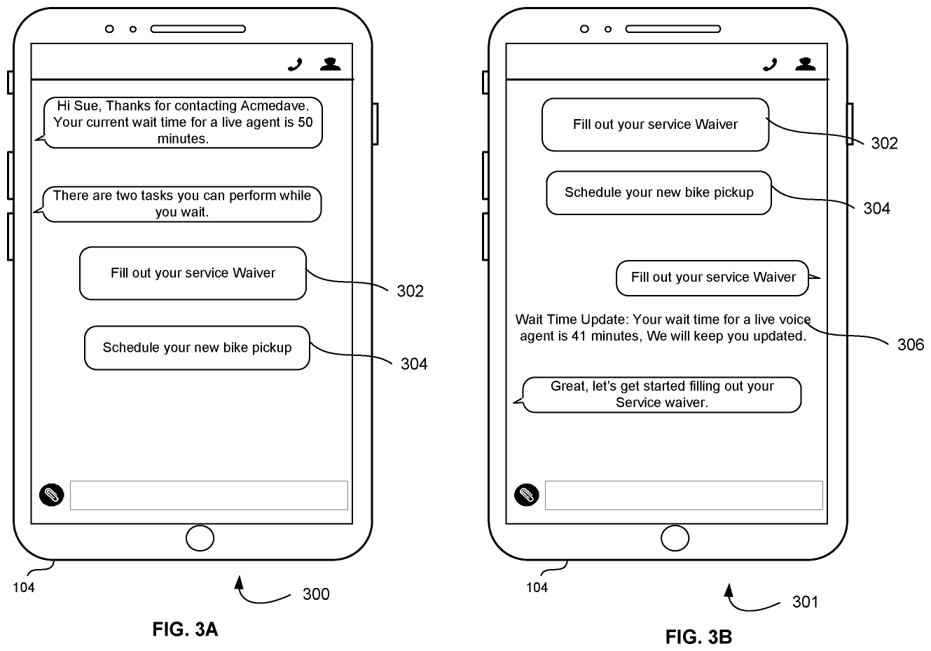

FIGS. 3A-3B illustrate user interface views of the customer device 104 of FIG. 1 that depicts providing a notification to the customer 102 with reference to a hold time to reach the live human agent 114 at the first live channel 110 according to some embodiments herein. In FIG. 3A, a user interface view 300 that depicts that the server 108 communicates with the customer 102 using the customer device 104 associated with the customer 102 through the network 106. The server 108 receives a call at a contact center from the customer 102. The customer 102 may reach the contact center via one or more channels such as voice, chat, messaging, social, SMS, or video. The server 108 provides a notification to the customer 102 with reference to a hold time to reach the live human agent 114 at the first live channel 110 (e.g., Hi Sue, Thanks for contacting Acmedave. Your current wait time for a live agent is 50 minutes.)

The server 108 enables the customer 102 to select an automation task to be performed while the customer 102 is waiting (e.g., There are two tasks you can perform while you wait). The server 108 enables the customer 102 to select the automation task such as Fill out your service Waiver 302 or Schedule your new bike pickup 304.

In FIG. 3B a user interface view 301 that depicts that the server 108 enables the customer 102 to select the automation task to be performed such as Fill out your service Waiver 302 or Schedule your new bike pickup 304. The customer 102 may select Fill out your service Waiver 302. The server 108 may notify the customer 102 about the hold time to reach the live human agent 114 at the first live channel 110 (e.g., Wait Time Update 306: Your wait time for a live voice agent is 41 minutes, we will keep you updated). The server 108 may enable the customer 102 to continue with the selected automation task (e.g., Great, let's get started filling out your Service waiver.)

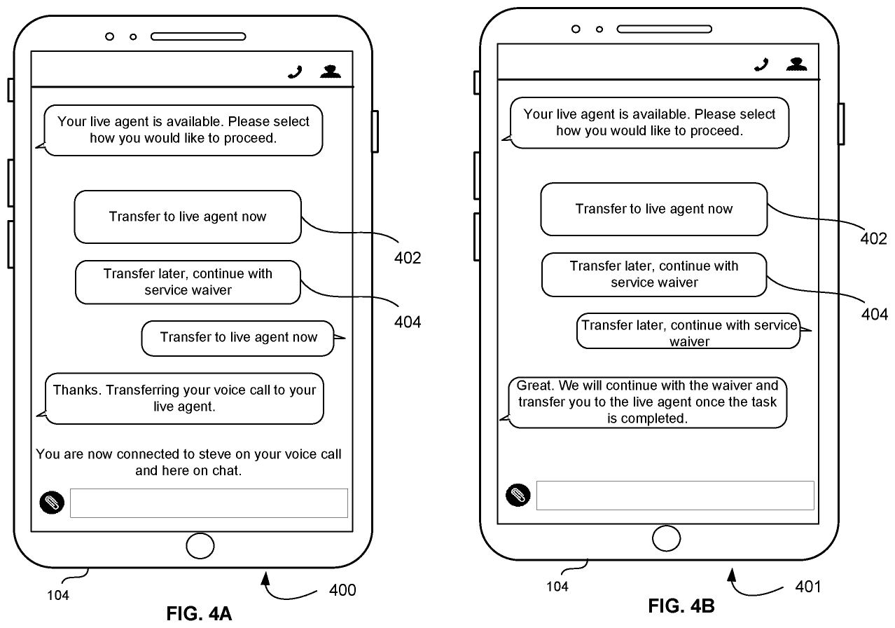

FIGS. 4A-4B illustrate user interface views of the customer device 104 of FIG. 1 that depicts checking, by the virtual agent 118, whether the customer 102 wants to continue to in the second non-live channel 116 to complete an automation task according to some embodiments herein. In FIG. 4A a user interface 400 depicts that the server 108 determines that the live human agent 114 is available in the first live channel 110. The virtual agent 118 may check whether the customer 102 wants to continue to in the second non-live channel 116 to complete the automation task, or transfer to the first live channel 110 to complete the automation task (e.g., Your live agent is available. Please select how you would like to proceed.). The virtual agent 118 may enable the customer 102 to select options such as Transfer to live agent now 402 and Transfer later, continue with service waiver 404. The customer 102 may select an option (e.g., Transfer to live agent now 402) as shown in FIG. 4A. The server 108 may transfer the customer 102 from the second non-live channel 116 to the first live channel 110 based on a selection of the customer 102 (e.g., Thanks. Transferring your voice call to your live agent).

In FIG. 4B a user interface 401 depicts that the server 108 determines that the live human agent 114 is available in the first live channel 110. The virtual agent 118 may check whether the customer 102 wants to continue to in the second non-live channel 116 to complete the automation task, or transfer to the first live channel 110 to complete the automation task (e.g., Your live agent is available. Please select how you would like to proceed.). The virtual agent 118 may enable the customer 102 to select options such as Transfer to live agent now 402 and Transfer later, continue with service waiver 404. The customer 102 may select an option (e.g., Transfer later, continue with service waiver 404) as shown in FIG. 4B. The server 108 may enable the customer 102 to continue his/her chat with the virtual agent 118 (e.g., Great. We will continue with the waiver and transfer you to the live agent once the task is completed).

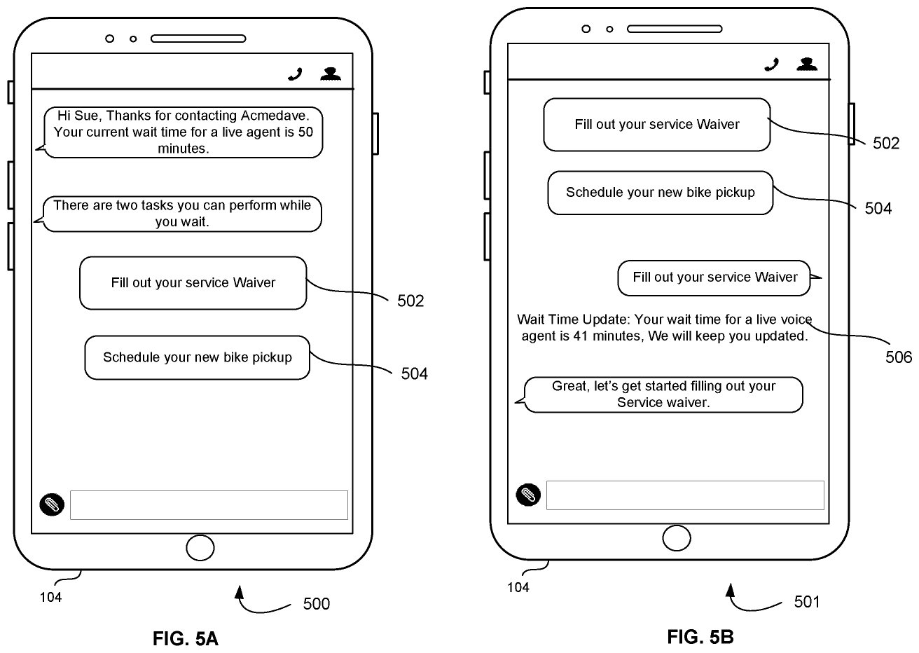

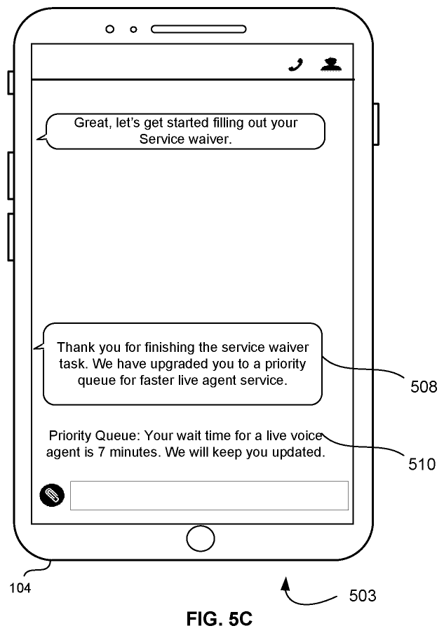

FIGS. 5A-5C illustrate user interface views of the customer device 104 of FIG. 1 that depicts transferring the customer 102 to a priority queue 510 that is different than an original queued priority in the first live channel 110 according to some embodiments herein. In FIG. 5A, a user interface view 500 that depicts that the server 108 communicates with the customer 102 using the customer device 104 associated with the customer 102 through the network 106. The server 108 receives a call at a contact center from the customer 102. The server 108 provides a notification to the customer 102 with reference to a hold time to reach the live human agent 114 at the first live channel 110 (e.g., Hi Sue, Thanks for contacting Acmedave. Your current wait time for a live agent is 50 minutes.) The server 108 enables the customer 102 to select an automation task to be performed while the customer 102 is waiting (e.g., There are two tasks you can perform while you wait). The server 108 enables the customer 102 to select the automation task such as Fill out your service Waiver 502 or Schedule your new bike pickup 504.

In FIG. 5B, a user interface view 501 that depicts that the server 108 enables the customer 102 to select the automation task to be performed such as Fill out your service Waiver 02 or Schedule your new bike pickup 504. The customer 102 may select Fill out your service Waiver 502. The server 108 may notify the customer 102 about the hold time to reach the live human agent 114 at the first live channel 110 (e.g., Wait Time Update 506: Your wait time for a live voice agent is 41 minutes, we will keep you updated). The server 108 may enable the customer 102 to continue with the selected automation task (e.g., Great, let's get started filling out your Service waiver.)

In FIG. 5C, a user interface view 503 depicts that the server 108 may notify the customer 102 about a status of the service waiver task if the customer 102 completed the service waiver task (e.g., Thank you for finishing the service waiver task. We have upgraded you to a priority queue for faster live agent service 508). The server 108 may enable the customer 102 to move to the first live channel 110 with the priority queue 510 that is different than an original queued priority in the first live channel 110 (Priority Queue 510: Your wait time for a live voice agent is 7 minutes. We will keep you updated).

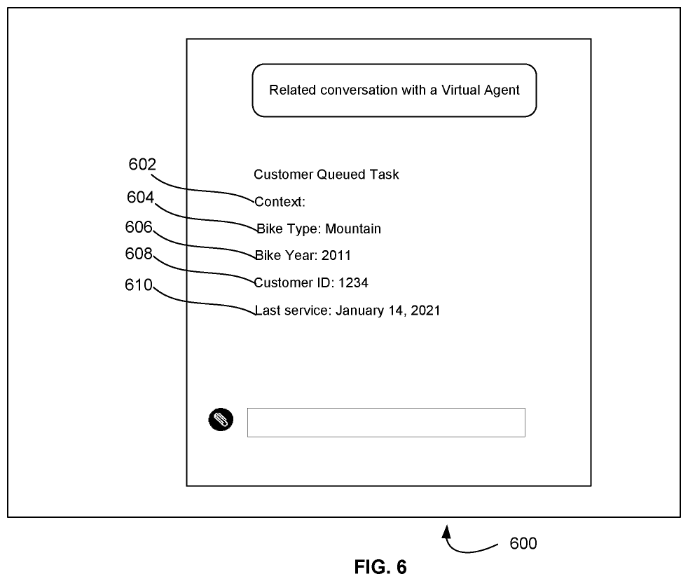

FIG. 6 is a user interface view 600 that depicts communicating a context 602 that corresponds to an interaction between the customer 102 and the virtual agent 118 in the second non-live channel 116, to the live human agent 114 in the first live channel 110 according to some embodiments herein. The context 602 may include (i) information that corresponds to a name, an account number, a reason for contact, product information, problem description, photos, videos that are gathered by the virtual agent 118 from the customer 102, (ii) pre-launch information that includes browser history, a location, an identity, information of the customer device 104 associated with customer 102. In FIG. 5, the context 602 may include bike type 604: Mountain, bike year 606:2011, customer ID 608: 1234, and Last service:610 Jan. 14, 2021.

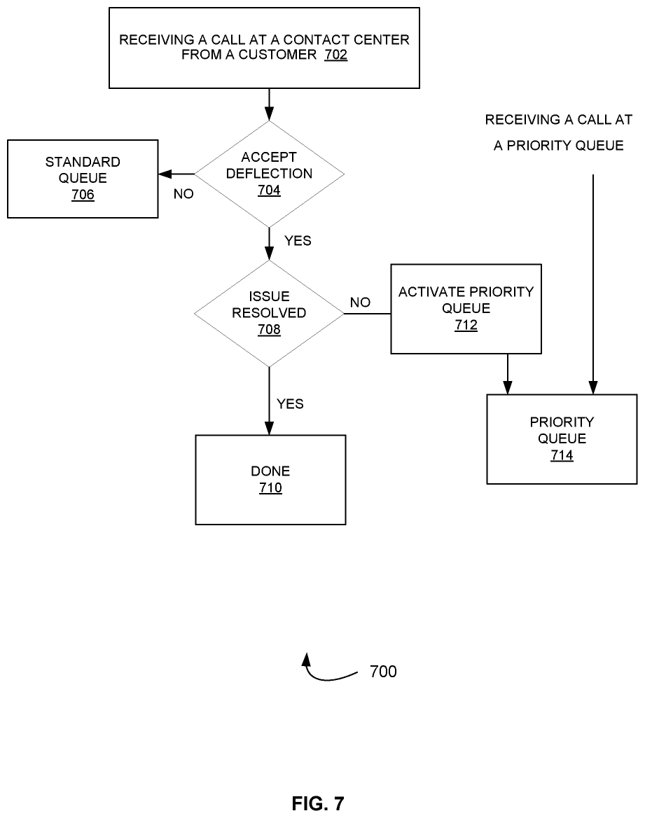

FIG. 7 is a flow diagram that illustrates a method 700 of enabling the customer 102 to call a priority queue in the first live channel 110 according to some embodiments herein. At step 702, a call is received at a contact center from the customer 102. At step 704, checked if the customer 102 accepts to wait to reach the live human agent 114 at the first live channel 110 with reference to a hold time if YES goes to step 508 or else goes to step 506. At step 706, the customer 102 is transferred to a standard queue. At step 708, checked if an issue raised by the customer 102 is resolved by the virtual agent 118 at the second non-live channel 116 if YES goes to step 710 or else goes to step 712. At step 710, this process is completed by the server 108 if the issue raised by the customer 102 is resolved. At step 712, the priority queue is activated in the first live channel 110 if the issue raised by the customer 102 is not resolved by the virtual agent 118 at the second non-live channel 116. In some embodiments, the server 108 activates the priority queue with a personalized priority customer service number, to accept calls temporarily from customer's mobile number. In some embodiments, the server 108 makes a call to the customer 102 based on the priority queue. In some embodiments, the server 108 connects the call to the priority customer service number when the customer 102 answers the call. At step 714, a call is received at the priority queue from the customer 102 and placed the customer 102 in the priority queue.

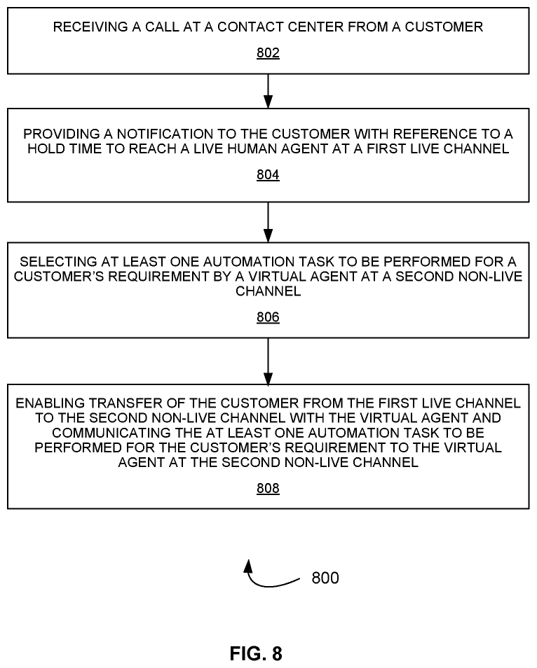

FIG. 8 is a flow diagram that illustrates a processor-implemented method 800 of enabling a customer support interaction in multiple channels in parallel according to some embodiments herein. At step 802, the processor-implemented method 800 includes receiving a call at a contact center from the customer 102. At step 804, the processor-implemented method 800 includes providing a notification to the customer 102 with reference to a hold time to reach the live human agent 114 at the first live channel 110. At step 806, the processor-implemented method 800 includes selecting one or more automation tasks to be performed for a customer's requirement by the virtual agent 118 at the second non-live channel 116. The one or more automation tasks is a series of steps performed by the virtual agent 118 to complete an objective. At step 808, the processor-implemented method 800 includes enabling transfer of the customer 102 from the first live channel 110 to the second non-live channel 116 with the virtual agent 118 and communicating the one or more automation tasks to be performed for the customer's requirement to the virtual agent 118 at the second non-live channel 116.

The embodiments herein may comprise a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules utilized herein include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

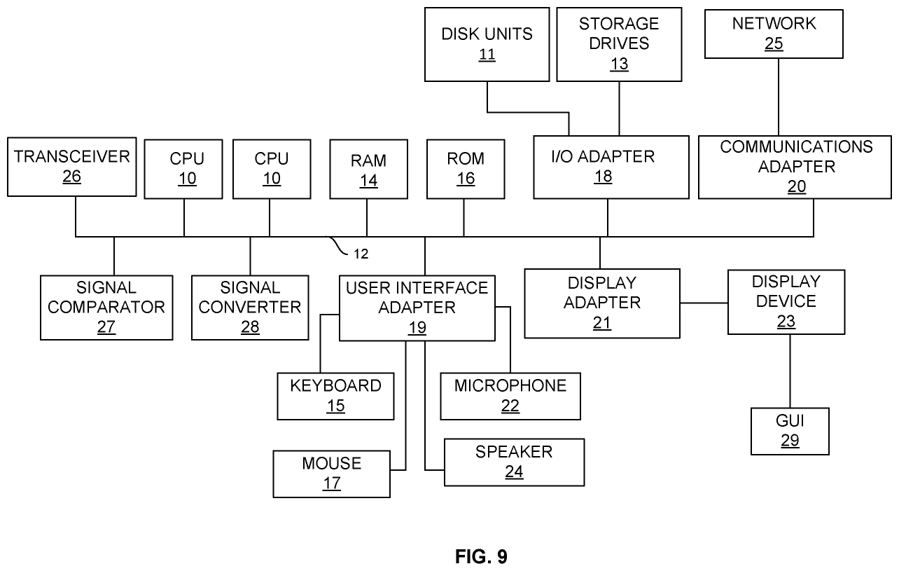

A representative hardware environment for practicing the embodiments herein is depicted in FIG. 9, with reference to FIGS. 1 through 8. This schematic drawing illustrates a hardware configuration of a server/computer system/computing device 108 in accordance with the embodiments herein. The server 108 comprises at least one processing device 10. The special-purpose CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The server 108 can read the inventive instructions on the program storage devices and follow these instructions to execute the methodology of the embodiments herein.

The server 108 further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor-implemented method of enabling a customer support interaction in multiple channels in parallel, the method comprising:
receiving a call at a contact center from a customer;
providing a notification to the customer with reference to a hold time to reach a live human agent at a first live channel;
selecting at least one automation task to be performed for a customer's requirement by a virtual agent at a second non-live channel, wherein the at least one automation task is a series of steps performed by the virtual agent to complete an objective; and
enabling transfer of the customer from the first live channel to the second non-live channel with the virtual agent and communicating the at least one automation task to be performed for the customer's requirement to the virtual agent at the second non-live channel.

2. The processor-implemented method of claim 1, further comprising
determining that the live human agent is available in the first live channel; and
enabling transfer of the customer from the second non-live channel to the first live channel if the live human agent becomes available in the first live channel.

3. The processor-implemented method of claim 1, wherein the multiple channels comprise real-time channels and non-real time channels, wherein the real-time channels are at least one of a voice channel or a video channel, wherein the non-real time channels are chat, messaging, social, or SMS.

4. The processor-implemented method of claim 1, wherein communicating the at least one automation task to be performed for the customer's requirement comprises communicating steps that are completed by the virtual agent at the second non-live channel, to the live human agent at the first live channel, wherein the at least one automation task comprises a start point, intermediate steps, and multiple completion paths.

5. The processor-implemented method of claim 3, wherein the steps are determined by at least one of (i) static definition, (ii) dynamic data based on a question and an answer with the customer, or (iii) Artificial intelligence (AI) driven prediction or recommendation based on customer input, dynamic data based on customer profile and transaction history, and other external indicators.

6. The processor-implemented method of claim 1, wherein enabling the transfer of the customer from the second non-live channel to the first live channel by determining that the at least one automation task to be performed for the customer's requirement is completed by the virtual agent at the second non-live channel.

7. The processor-implemented method of claim 1, further comprising enabling the customer to select the at least one automation task to be performed by the virtual agent at the second non-live channel.

8. The processor-implemented method of claim 1, further comprising when the live human agent is available at the first live channel, checking, by the virtual agent, whether the customer wants to continue to in the second non-live channel to complete the at least one automation task, or transfer to the first live channel to complete the at least one automation task.

9. The processor-implemented method of claim 1, further comprising if the at least one automation task is completed at the second non-live channel, moving the customer from the second non-live channel to the first live channel with a priority queue that is different than an original queued priority in the first live channel.

10. The processor-implemented method of claim 1, further comprising if the at least one automation task is completed at the second non-live channel, moving the customer from the second non-live channel to the first live channel in a queue position that is same as the queue position of the customer previously interacted at the first live channel.

11. The processor-implemented method of claim 1, further comprising providing the notification to switch the customer from the second non-live channel with the virtual agent to the first live channel with the live human agent if the live human agent is available in the first live channel at the contact center.

12. The processor-implemented method of claim 11, further comprising communicating a state and context that correspond to an interaction between the customer and the virtual agent in the second non-live channel, to the live human agent in the first live channel.

13. The processor-implemented method of claim 12, wherein the context comprises (i) information that corresponds to a name, an account number, a reason for contact, product information, problem description, photos, videos that are gathered by the virtual agent from the customer, (ii) pre-launch information that comprises browser history, a location, an identity, information of the customer device associated with the customer.

14. The processor-implemented method of claim 12, wherein the state is at least one of a current business situation that comprises information related to a business busy level, hours of operation, current level achieved on a promotion or sales target, or other current metrics related to business capacity or goals.

15. The processor-implemented method of claim 1, further comprising
determining, by the virtual agent in the second non-live channel, that a specific task needs to be performed by the live human agent at the first live channel for the customer's requirement.

16. A system for enabling a customer support interaction in multiple channels in parallel, the system comprising:
a memory that stores a set of instructions; and
a processor that executes the set of instructions and is configured to:
receive a call at a contact center from a customer;
provide a notification to the customer with reference to a hold time to reach a live human agent at a first live channel;
select at least one automation task to be performed for a customer's requirement by a virtual agent at a second non-live channel, wherein the at least one automation task is a series of steps performed by the virtual agent to complete an objective; and
enable transfer of the customer from the first live channel to the second non-live channel with the virtual agent and communicate the at least one automation task to be performed for the customer's requirement to the virtual agent at the second non-live channel.

17. The system of claim 16, wherein the processor further configured to
determine that the live human agent is available in the first live channel; and
enable the transfer of the customer from the second non-live channel to the first live channel if the live human agent becomes available in the first live channel.

18. The system of claim 16, wherein the processor communicates the at least one automation task to be performed for the customer's requirement comprises communicates steps that are completed by the virtual agent at the second non-channel, to the live human agent at the first live channel, wherein the at least one task comprises a start point, intermediate steps, and multiple completion paths.

19. The system of claim 16, wherein the processor enables the transfer of the customer from the second non-live channel to the first live channel by determining that the at least one automation task to be performed for the customer's requirement is completed by the virtual agent at the second non-live channel.

20. The system of claim 16, wherein the processor is further configured to move the customer from the second non-live channel to the first live channel with a priority queue that is different than an original queued priority in the first live channel if the at least one automation task is completed at the second non-live channel.
